(19) United States
(12) Patent Application Publication
(10) Pub. No.: US 2020/0096242 A1
(43) Pub. Date: Mar. 26, 2020

(54) PRESSURE DAM BEARING

(71) Applicant: Johnson Controls Technology Company, Auburn Hills, MI (US)

(72) Inventors: Matthew L. Heisey, York, PA (US); Paul W. Snell, York, PA (US)

(73) Assignee: Johnson Controls Technology Company, Auburn Hills, MI (US)

(21) Appl. No.: 16/495,772

(22) PCT Filed: Mar. 23, 2018
(86) PCT No.: PCT/US2018/024097

§ 371 Date: Sep. 19, 2019

Related U.S. Application Data
(60) Provisional application No. 62/476,441, filed on Mar. 24, 2017.

(51) Int. Cl. F25B 31/02; F04D 29/057; F04D 25/06; F04D 17/10; F04D 29/063; H02K 5/167; H02K 7/08; H02K 7/14; F16C 33/66

(52) U.S. Cl. CPC F25B 31/026; F04D 29/057; F04D 25/06; F04D 17/10; F04D 29/063; F16C 2360/44; H02K 7/083; H02K 7/14; F16C 33/6659; H02K 2205/09; H02K 5/1672

(57) ABSTRACT

A motor is configured to drive a centrifugal compressor. The motor includes a stator, a rotor, and a shaft. The shaft is supported by a pressure dam bearing (230,240). The pressure dam bearing is lubricated with a lubricant. The lubricant creates a lubricant wedge within the pressure dam bearing that exert an upward force on the shaft. The upward force causes an amount of vibration within the motor. The pressure dam bearing includes a pressure dam (232,242) configured to hold a portion of the lubricant and exert a downward force on the shaft. The downward force balances the upward force and reduces the amount of vibration within the motor, thus achieving greater hydrodynamic stabilization.

### CROSS-REFERENCE TO RELATED PATENT APPLICATION

This application claims the benefit of and priority to U.S. Provisional Patent Application No. 62/476,441 filed Mar. 24, 2017, the entire disclosure of which is incorporated by reference herein.

### BACKGROUND

Buildings can include heating, ventilation and air conditioning (HVAC) systems.

### SUMMARY

One implementation of the present disclosure is a motor assembly including a motor configured to drive a centrifugal compressor. The motor includes a stator configured to receive AC power and generate a magnetic field. The motor further includes a rotor configured to rotate about an axis in response to an electromagnetic force generated by the magnetic field. The motor further includes a shaft connected to the rotor and configured to drive the centrifugal compressor. The shaft is supported by a pressure dam bearing. The pressure dam bearing is lubricated with a lubricant. The lubricant creates a lubricant wedge within the pressure dam bearing. The lubricant wedge exerts an upward force on the shaft. The upward force causes an amount of vibration within the motor. The pressure dam bearing includes a pressure dam configured to hold a portion of the lubricant. The pressure dam is further configured to exert a downward force on the shaft. The downward force balances the upward force and reduces the amount of vibration within the motor.

Another implementation of the present disclosure is a chiller assembly. The chiller assembly includes an evaporator configured to convert a liquid into a vapor. The chiller assembly further includes a condenser configured to convert the vapor into a liquid. The chiller assembly further includes a suction line configured to transfer the vapor from the evaporator to a centrifugal compressor. The chiller assembly further includes a discharge line configured to transfer the vapor from the centrifugal compressor to the condenser. The chiller assembly further includes a motor assembly including a motor configured to drive the centrifugal compressor. The motor includes a stator configured to receive AC power and generate a magnetic field. The motor further includes a rotor configured to rotate about an axis in response to an electromagnetic force generated by the magnetic field. The motor further includes a shaft connected to the rotor and configured to drive the centrifugal compressor. The shaft is supported by a pressure dam bearing. The pressure dam bearing is lubricated with a lubricant. The lubricant creates a lubricant wedge within the pressure dam bearing. The lubricant wedge exerts an upward force on the shaft. The upward force causes an amount of vibration within the motor. The pressure dam bearing includes a pressure dam configured to hold a portion of the lubricant. The pressure dam is further configured to exert a downward force on the shaft. The downward force balances the upward force and reduces the amount of vibration within the motor.

Another implementation of the present disclosure is a method. The method includes providing a motor assembly including a motor configured to drive a centrifugal compressor. The motor includes a stator configured to receive AC power and generate a magnetic field. The motor further includes a rotor configured to rotate about an axis in response to an electromagnetic force generated by the magnetic field. The motor further includes a shaft connected to the rotor and configured to drive the centrifugal compressor. The shaft is supported by a pressure dam bearing. The pressure dam bearing is lubricated with a lubricant. The lubricant creates a lubricant wedge within the pressure dam bearing. The lubricant wedge exerts an upward force on the shaft. The upward force causes an amount of vibration within the motor. The pressure dam bearing includes a pressure dam configured to hold a portion of the lubricant. The pressure dam is further configured to exert a downward force on the shaft. The downward force balances the upward force and reduces the amount of vibration within the motor.

### BRIEF DESCRIPTION OF THE DRAWINGS

FIG. 1 is a drawing of a chiller assembly.

FIG. 2 is a drawing of an induction motor within the chiller assembly of FIG. 1.

FIG. 3 is a drawing of a pressure dam bearing installed at the drive end of the motor of FIG. 2.

FIG. 4 is another drawing of the bearing of FIG. 3.

FIG. 5 is a cross-sectional view drawing of the bearing of FIG. 3.

FIG. 6 is a drawing of a pressure dam bearing installed at the non-drive end of the motor of FIG. 2

FIG. 7 is another drawing of the bearing of FIG. 6.

FIG. 8 is a cross-sectional view drawing of the bearing of FIG. 6.

FIG. 9 is a drawing of dimensional characteristics associated with bearing of FIG. 3 and the bearing of FIG. 6.

FIG. 10 is a drawing of a pressure profile associated with bearing of FIG. 3 and the bearing of FIG. 6.

### DETAILED DESCRIPTION

Referring generally to the FIGURES, a motor assembly configured to drive a compressor is shown. The motor assembly, which can be referred to herein as a motor, can include a high speed induction motor configured to directly drive a centrifugal compressor as part of a chiller assembly. The chiller assembly can be configured to perform a refrigerant vapor compression cycle in an HVAC system. The motor includes a first pressure dam bearing located at the drive end of the motor and a second pressure dam bearing located at the non-drive end of the motor. The pressure dam bearings are lubricated and include a pressure dam configured to exert a downward force on the motor shaft. The downward force can balance an upward force exerted on the motor shaft by a lubricant wedge formed within the bearings. As a result, the system can achieve greater stability and avoid vibration caused by effects such as oil whirl. In addition, the pressure dam bearings can maintain sufficient stiffness at a wide range of operating speeds for improved rotor dynamics. The pressure dam bearings can extend the lifetime of various motor components (e.g., shaft, rotor, stator) as well as drive increased efficiency and performance of the chiller assembly.

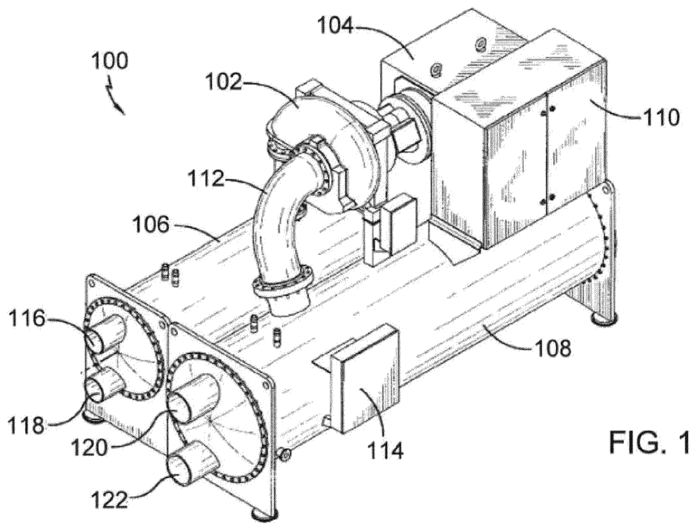

Referring specifically to FIG. 1, an example implementation of a chiller assembly 100 is shown. Chiller assembly 100 is shown to include a compressor 102 driven by a motor 104, a condenser 106, and an evaporator 108. A refrigerant is circulated through chiller assembly 100 in a vapor compression cycle. Chiller assembly 100 can also include a control panel 114 to control operation of the vapor compression cycle within chiller assembly 100. Control panel 114 may be connected to an electronic network in order to share a variety of data related to maintenance, analytics, etc.

Motor 104 can be powered by a variable speed drive (VSD) 110. VSD 110 receives alternating current (AC) power having a particular fixed line voltage and fixed line frequency from an AC power source (not shown) and provides power having a variable voltage and frequency to motor 104. Motor 104 can be any type of electric motor than can be powered by a VSD 110. For example, motor 104 can be a high speed induction motor. Compressor 102 is driven by motor 104 to compress a refrigerant vapor received from evaporator 108 through a suction line 112. Compressor 102 then delivers compressed refrigerant vapor to condenser 106 through a discharge line. Compressor 102 can be a centrifugal compressor, a screw compressor, a scroll compressor, a turbine compressor, or any other type of suitable compressor.

Evaporator 108 includes an internal tube bundle (not shown), a supply line 120, and a return line 122 for supplying and removing a process fluid to the internal tube bundle. The supply line 120 and the return line 122 can be in fluid communication with a component within a HVAC system (e.g., an air handler) via conduits that circulate the process fluid. The process fluid is a chilled liquid for cooling a building and can be, but is not limited to, water, ethylene glycol, calcium chloride brine, sodium chloride brine, or any other suitable liquid. Evaporator 108 is configured to lower the temperature of the process fluid as the process fluid passes through the tube bundle of evaporator 108 and exchanges heat with the refrigerant. Refrigerant vapor is formed in evaporator 108 by the refrigerant liquid delivered to the evaporator 108 exchanging heat with the process fluid and undergoing a phase change to refrigerant vapor.

Refrigerant vapor delivered by compressor 102 to condenser 106 transfers heat to a fluid. Refrigerant vapor condenses to refrigerant liquid in condenser 106 as a result of heat transfer with the fluid. The refrigerant liquid from condenser 106 flows through an expansion device and is returned to evaporator 108 to complete the refrigerant cycle of the chiller assembly 100. Condenser 106 includes a supply line 116 and a return line 118 for circulating fluid between the condenser 106 and an external component of the HVAC system (e.g., a cooling tower). Fluid supplied to the condenser 106 via return line 118 exchanges heat with the refrigerant in the condenser 106 and is removed from the condenser 106 via supply line 116 to complete the cycle. The fluid circulating through the condenser 106 can be water or any other suitable liquid.

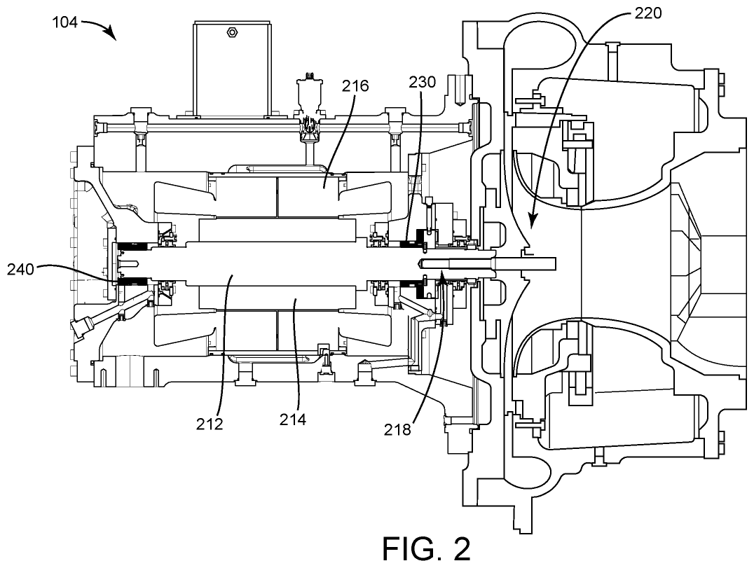

Referring now to FIG. 2, a more detailed drawing of motor 104 is shown. Motor 104 can be a high speed induction motor configured to directly drive a centrifugal compressor (i.e., compressor 102). Motor 104 is shown to include a shaft 212, a rotor 214, and a stator 216. Stator 216 is supplied with AC power (e.g., from VSD 110) and includes windings that can generate a magnetic field. The magnetic field can induce an electromagnetic force that produces a torque around the axis of rotor 214. As a result, rotor 214 and shaft 212 begin to rotate in a circular motion. Shaft 212 can be connected to an impeller 220 of compressor 102 via a direct drive mechanism 218. Impeller 220 can therefore be configured to rotate at a high speed in order to raise the pressure of refrigerant vapor within compressor 102.

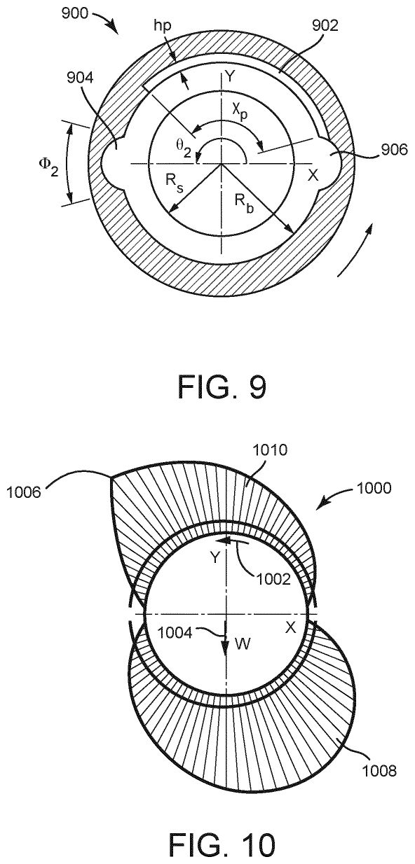

In some applications, a lightly loaded rotor shaft supported by simple plain-bore style fluid film bearings can be subject to rotordynamic instability and vibration. Motor 104 is shown to include a first pressure dam bearing 230 located at the drive end of motor 104 and a second pressure dam bearing 240 located at the non-drive end of motor 104. Bearings 230 and 240 support shaft 212 and can be lubricated with oil or another type of lubricant. As motor 104 is energized and shaft 212 begins to rotate, shaft 212 may ride on a thin film of lubricant that coats the inside of bearings 230 and 240. This lubricant wedge creates a significant amount of pressure underneath shaft 212 that forces shaft 212 in an upwards direction. In addition, depending on rotational direction, the lubricant wedge can also force shaft 212 in a slightly lateral direction. The amount of pressure exerted on shaft 212 can vary depending on the speed of rotor 214, the weight of rotor 214, the pressure of the lubricant, and various other factors. When a disturbance is introduced in the system, shaft 212 can stray from its equilibrium position and the lubricant can cause an instable oil whirl effect. The oil whirl effect can drive the shaft into a whirling path and create vibration at a frequency around half the rotating speed of shaft 212. As a result, certain components of motor 104 can wear out faster and overall performance of motor 104 can suffer. In order to balance the upward force exerted on shaft 212 by the lubricant wedge, bearings 230 and 240 include a pressure dam fabricated into the top (i.e., unloaded) half of the bore of the bearing. These pressure dams can hold a portion of the lubricant and create a downward force on shaft 212. This hydrodynamic stabilizing force can sufficiently load the lubricant wedges in order to balance the upward force, thus stabilizing shaft 212 within bearings 230 and 240. More detail regarding the pressure dam design and pressure profile for bearings 230 and 240 is described below with reference to FIGS. 9 and 10.

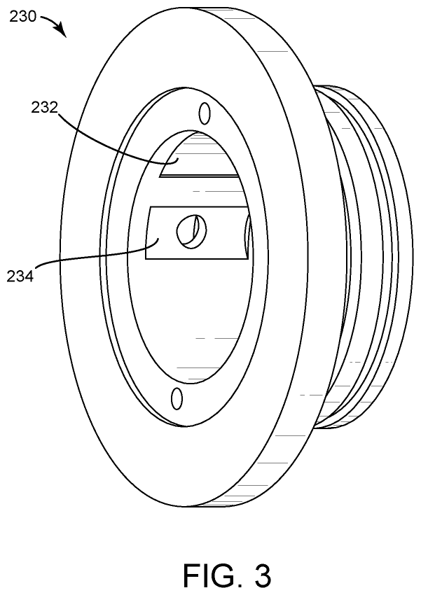

Referring now to FIG. 3, a drawing of pressure dam bearing 230 is shown. Bearing 230 is a hydrodynamic journal bearing that contains two lobes and two axial grooves. Axial groove 234 can be seen in FIG. 3, however the second axial groove (i.e., axial groove 236) is not shown since it is directly opposite (i.e., 180°) axial groove 234. Also shown in FIG. 3 is a pressure dam 232 configured to generate a downward force on shaft 212 during operation of motor 104.

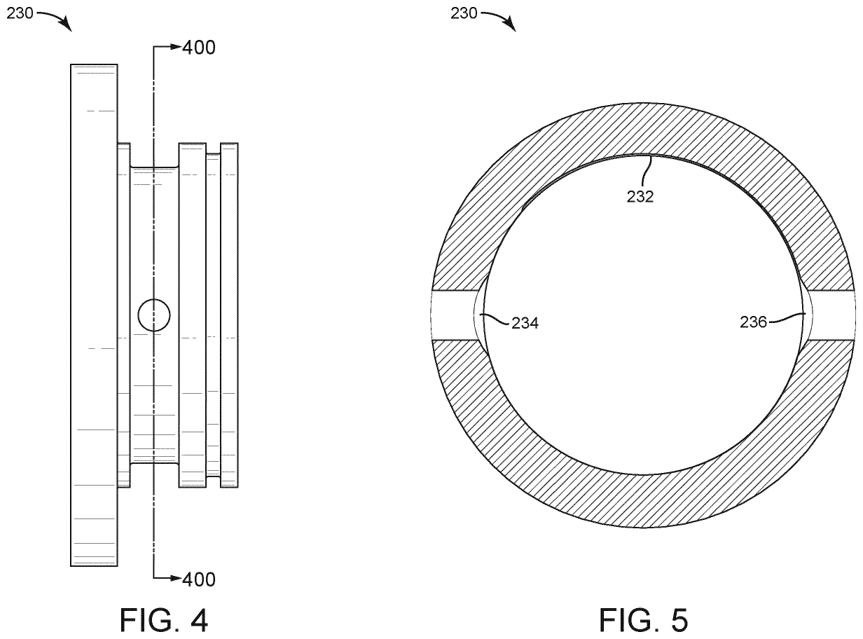

Referring now to FIG. 4, another drawing of pressure dam bearing 230 is shown. FIG. 4 depicts a cross-sectional line 400 from which the drawing of FIG. 5 is produced. Referring now to FIG. 5, both of axial grooves 234 and 236 are shown. In addition, pressure dam 232 is shown along the top surface of the bore of bearing 230. Pressure dam 232 is shown to have an arc length of about 140°-150°. More detail about the advantages associated with this structure is presented below with respect to FIGS. 9 and 10.

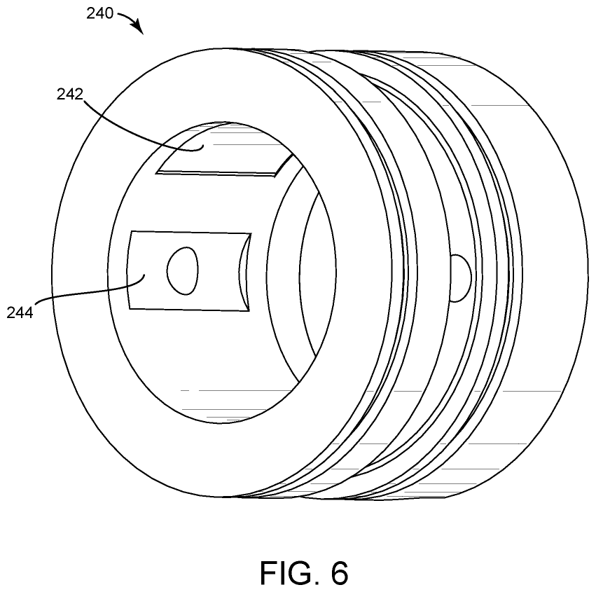

Referring now to FIG. 6, a drawing of pressure dam bearing 240 is shown. Bearing 240 is also a hydrodynamic journal bearing that contains two lobes and two axial grooves. However, similar to FIG. 3, only axial groove 244 can be seen in FIG. 6. The second axial groove (i.e., axial groove 246) is directly opposite axial groove 244. In addition, pressure dam 242 is shown along the top surface of the bore of bearing 240 (i.e., unloaded half). Similar to pressure dam 232, pressure dam 242 can be configured to generate a downward force on shaft 212 during operation of motor 104. This downward pressure helps balance the upward pressure on shaft 212 created by the lubricant wedge within bearing 240.

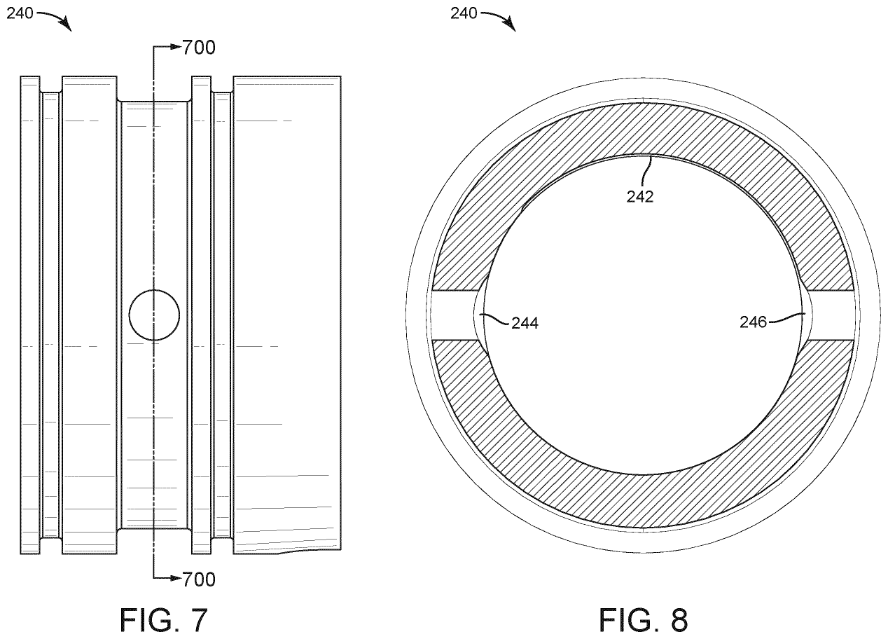

Referring now to FIG. 7, another drawing of pressure dam bearing 240 is shown. Similar to FIG. 4, FIG. 7 depicts a cross-sectional line 700 from which the drawing of FIG. 8 is produced. Referring now to FIG. 8, both of axial grooves 244 and 246 can be seen. In addition, pressure dam 242 is shown along the top surface of the bore of bearing 240 and is shown to have an arc length of about 140°-150°. More detail about the advantages associated with this structure is presented below with respect to FIGS. 9 and 10.

Referring now to FIG. 9, an illustration of dimensional characteristics associated with an example pressure dam bearing 900 is shown. Bearing 900 can be identical or nearly identical to bearings 230 and 240 and is provided as an example from which various features and dimensional relationships associated with bearings 230 and 240 can be inferred. For example, bearing 900 is shown to include a pressure dam 902 (e.g., analogous to pressure dams 232 and 242) and two axial grooves 904 and 906 (e.g., analogous to axial grooves 234/236 and 244/246). A description of each variable shown in FIG. 9 is presented below in Table 1. Typical values consistent with the present disclosure are included for each variable in Table 1.

TABLE 1
Dimensional Characteristics Shown in FIG. 9

| Variable | Description | Value |
|---|---|---|
| χₚ | Pressure dam arc length | 140° to 150° |
| hₚ | Pressure dam depth | 0.15 mm to 0.20 mm |
| θ₂ | Axial groove separation | 180° |
| ϕ₂ | Axial groove arc length | 11° to 27° |
| C_{d} | Clearance diameter | 0.08 mm to 0.12 mm |
| | C_{d} = 2 (R_{b} − Rₛ) | |
| | R_{b} = Radius of bore | |
| | Rₛ = Radius of shaft | |

Referring now to FIG. 10, a drawing of a pressure profile 1000 associated with pressure dam bearings 230 and 240 is shown. Pressure profile 1000 is shown to include arrows 1002 and 1004. Arrow 1002 represents the rotational direction of shaft 212. In this case, shaft 212 is rotating in a counter-clockwise direction. Arrow 1004 represents a resting weight of shaft 212 on the bottom (i.e., loaded) surface of the bore of the bearing. Pressure region 1008 represents pressure formed underneath shaft 212 via the lubricant wedge formed on the loaded half of the bore of the bearing. Pressure region 1008 is shown to be slightly asymmetrical since the pressure formed by the lubricant wedge also exerts a slightly lateral force on shaft 212. This lateral increase in pressure can be seen in the positive x-direction, however if the shaft was rotating in a clockwise direction this lateral pressure increase would be in the negative x-direction. In order to balance the upward force exerted on shaft 212 by pressure region 1008, the pressure dam (e.g., pressure dam 232 or 242) houses a portion of the lubricant and creates a strong region of pressure on the top (i.e., unloaded) surface of the bore of the bearing. This pressure is shown by region 1010 and is at a maximum 1006 in a radial direction that aligns with the edge of the pressure dam. Since the pressure dam has an arc length of about 140°-150°, maximum pressure 1006 can be seen in the negative x-direction and can balance out some or all of the lateral pressure in the positive x-direction depicted in region 1008.

As can be inferred from pressure profile 1000, pressure dams 232 and 242 increase the stability of motor 104. As a result, when various disturbances are introduced to the system, negative effects such as oil whirl and oil whip are less likely to occur. In addition, bearings 230 and 240 can deliver sufficient bearing stiffness at various motor speeds while also delivering increased stability. The “smooth” operation of motor 104 driven by pressure dam bearings 230 and 240 allows various components of chiller assembly 100 to realize a longer lifetime and require less maintenance. The use of pressure dam bearings 230 and 240 can drive increased overall efficiency and performance of chiller assembly 100.

The construction and arrangement of the systems and methods as shown in the various exemplary embodiments are illustrative only. Although only example embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

What is claimed is:

1. A motor assembly including a motor configured to drive a centrifugal compressor, the motor assembly comprising:
a stator configured to receive AC power and generate a magnetic field;
a rotor configured to rotate about an axis in response to an electromagnetic force generated by the magnetic field; and
a shaft connected to the rotor and configured to drive the centrifugal compressor, wherein the shaft is supported by a pressure dam bearing;
wherein the pressure dam bearing is lubricated with a lubricant, the lubricant creating a lubricant wedge within the pressure dam bearing, the lubricant wedge exerting an upward force on the shaft, the upward force causing an amount of vibration within the motor; and
wherein the pressure dam bearing includes a pressure dam configured to hold a portion of the lubricant, the pressure dam further configured to exert a downward force on the shaft, the downward force balancing the upward force to reduce the amount of vibration within the motor.

2. The motor assembly of claim 1, wherein the motor is configured to directly drive the centrifugal compressor.

3. The motor assembly of claim 1, wherein the motor operates as part of a chiller assembly, the chiller assembly including an evaporator configured to convert a liquid refrigerant into a refrigerant vapor and a condenser configured to convert the refrigerant vapor into a liquid refrigerant.

4. The motor assembly of claim 3, wherein the chiller assembly further includes a suction line configured to transfer the refrigerant vapor from the evaporator to the centrifugal compressor and a discharge line configured to transfer the refrigerant vapor from the centrifugal compressor to the condenser.

5. The motor assembly of claim 4, wherein the centrifugal compressor includes an impeller, the impeller connected to the shaft and configured to increase the pressure of the refrigerant vapor.

6. The motor assembly of claim 5, wherein the chiller assembly further includes a variable speed drive (VSD) configured to provide the AC power to the motor.

7. The motor assembly of claim 1, wherein the pressure dam bearing has two lobes.

8. The motor assembly of claim 7, wherein each of the two lobes has an arc length that ranges from 11° to 27°.

9. The motor assembly of claim 1, wherein the two lobes are separated by an arc length of 180°.

10. The motor assembly of claim 9, wherein each of the pressure dam has a depth that ranges from 0.15 millimeters and 0.20 millimeters.

11. The motor assembly of claim 1, wherein the pressure dam has an arc length that ranges from 140° to 150°.

12. The motor assembly of claim 1, wherein the pressure dam bearing has a clearance diameter that ranges from 0.08 millimeters and 0.12 millimeters.

13. The motor assembly of claim 1, wherein the lubricant wedge exerts a first lateral force on the shaft, the direction of the first lateral force depending on a rotational direction of the shaft.

14. The motor assembly of claim 13, wherein the pressure dam exerts a second lateral force on the shaft, the second lateral force exerted in an opposite direction of the first lateral force.

15. The motor assembly of claim 1, wherein the pressure dam is located on a top surface of a bore of the pressure dam bearing.

16. A chiller assembly, comprising:
an evaporator configured to convert a liquid refrigerant into a refrigerant vapor;
a condenser configured to convert the refrigerant vapor into the liquid refrigerant. a suction line configured to transfer the refrigerant vapor from the evaporator to a centrifugal compressor;
a discharge line configured to transfer the refrigerant vapor from the centrifugal compressor to the condenser; and
a motor assembly including a motor configured to drive the centrifugal compressor, the motor assembly comprising:
a stator configured to receive AC power and generate a magnetic field;
a rotor configured to rotate about an axis in response to an electromagnetic force generated by the magnetic field; and
a shaft connected to the rotor and configured to drive the centrifugal compressor, wherein the shaft is supported by a pressure dam bearing;
wherein the pressure dam bearing is lubricated with a lubricant, the lubricant creating a lubricant wedge within the pressure dam bearing, the lubricant wedge exerting an upward force on the shaft, the upward force causing an amount of vibration within the motor; and
wherein the pressure dam bearing includes a pressure dam, the pressure dam configured to hold a portion of the lubricant, the pressure dam further configured to exert a downward force on the shaft, the downward force balancing the upward force and reducing the amount of vibration within the motor.

17. The chiller assembly claim 16, wherein the pressure dam has a depth that ranges from 0.15 millimeters and 0.20 millimeters.

18. The chiller assembly of claim 16, wherein the pressure dam has an arc length that ranges from 140° to 150°.

19. The chiller assembly of claim 16, wherein the lubricant wedge exerts a first lateral force on the shaft, the direction of the first lateral force depending on a rotational direction of the shaft, and wherein the pressure dam exerts a second lateral force on the shaft, the second lateral force exerted in an opposite direction of the first lateral force.

20. A method, comprising:
providing a motor assembly including a motor configured to drive a centrifugal compressor, the motor assembly comprising:
a stator configured to receive AC power and generate a magnetic field;
a rotor configured to rotate about an axis in response to an electromagnetic force generated by the magnetic field; and
a shaft connected to the rotor and configured to drive the centrifugal compressor, wherein the shaft is supported by a pressure dam bearing;
wherein the pressure dam bearing is lubricated with a lubricant, the lubricant creating a lubricant wedge within the pressure dam bearing, the lubricant wedge exerting an upward force on the shaft, the upward force causing an amount of vibration within the motor; and
wherein the pressure dam bearing includes a pressure dam, the pressure dam configured to hold a portion of the lubricant, the pressure dam further configured to exert a downward force on the shaft, the downward force balancing the upward force and reducing the amount of vibration within the motor.
